(19) United States
(12) Patent Application Publication
(10) Pub. No.: US 2024/0330327 A1
(43) Pub. Date: Oct. 3, 2024

(54) ACCELERATION OF INFLIGHT DEPLOYMENTS

(71) Applicant: INTERNATIONAL BUSINESS MACHINES CORPORATION, Armonk, NY (US)

(72) Inventors: Siddhartha SOOD, Ghaziabad (IN); Shweta VOHRA, Bangalore (IN); Madhusmita PATIL, Hyderabad (IN); Harish BHARTI, Pune (IN); Balakrishnan SREENIVASAN, Jayanagar (IN)

(73) Assignee: INTERNATIONAL BUSINESS MACHINES CORPORATION, Armonk, NY (US)

(21) Appl. No.: 18/193,281

(22) Filed: Mar. 30, 2023

(51) Int. Cl. G06F 16/28; G06F 8/71

(52) U.S. Cl. CPC G06F 16/288; G06F 8/71; G06F 16/285

(57) ABSTRACT

Leveraging production deployments to accelerate inflight deployments in a computing environment. A component is extracted, which is identified in the production deployment. The identified, extracted component is analyzed to derive a set of data describing the identified, extracted component. A relationship between the data is built. The relationship is used to develop an enterprise-wide methodology that is utilized to accelerate development of an additional, inflight deployment by comparing the additional, inflight deployment against the developed methodology.

### BACKGROUND

The present invention relates in general to computing systems, and more particularly, to various embodiments for leveraging production deployments to accelerate inflight deployments in a computing environment.

### SUMMARY

According to an embodiment of the present invention, a method for leveraging production deployments to accelerate inflight deployments in a computing environment using a computing processor, is depicted. A component which is identified in the production deployment, is extracted. The identified, extracted component is analyzed to derive a set of data describing the identified, extracted component. A relationship between the data, is built. The relationship is used to develop an enterprise-wide methodology, that is then utilized to accelerate development of an additional, inflight deployment by, among other aspects, comparing the additional, inflight deployment against the developed methodology.

An embodiment includes a computer usable program product. The computer usable program product includes a computer-readable storage device, and program instructions stored on the storage device.

An embodiment includes a computer system. The computer system includes a processor, a computer-readable memory, and a computer-readable storage device, and program instructions stored on the storage device for execution by the processor via the memory.

Thus, in addition to the foregoing exemplary method embodiments, other exemplary system and computer product embodiments are provided.

### BRIEF DESCRIPTION OF THE DRAWINGS

FIG. 1 is a block diagram depicting a computing environment according to an embodiment of the present invention.

FIG. 2 is a block/flow chart diagram that depicts exemplary relationships between various aspects of a typical operating model for development of a modern application.

FIG. 3 is a flow chart diagram depicting a typical lifecycle of the modern application depicted in FIG. 2, previously.

FIG. 4 is a is a flowchart diagram depicting an exemplary method for, among other aspects, leveraging production deployments to accelerate inflight deployments in a computing environment according to an embodiment of the present invention.

FIG. 5 is an additional flowchart diagram depicting an additional exemplary method for, among other aspects, accelerating an inflight implementation critical review in a computing environment according to an embodiment of the present invention.

FIG. 6 is an additional flowchart diagram depicting exemplary scenarios implementing various aspects of the present invention, including, but not limited to accessing drift from gold standards, extracting specific pattern implementation and/or best practices information, and creating blueprints for a new build, here again according to an embodiment of the present invention.

FIG. 7 is an additional block diagram depicting an additional exemplary scenario implementing various aspects of the present invention, including leveraging one or more identified cloud components, one or more identified guided patterns, and codified reference implementations across multiple clouds demonstrating an end-to-end working of an exemplary use case, according to an embodiment of the present invention.

FIG. 8 is an additional flow chart diagram depicting an additional exemplary method for accelerating an inflight deployment by leveraging various identified and extracted components, patterns, and other aspects of one or more production deployments according to an embodiment of the present invention.

FIG. 9 is a spreadsheet diagram of an exemplary decision matrix based on one or more aspects illustrated in the flow chart diagram previously illustrated in FIG. 10, here again according to an embodiment of the present invention.

FIG. 10 is a spreadsheet diagram of an exemplary system compute component level, pattern level, stakeholder level, and overall application level aggregate score, in which various aspects of the previous diagrams may be implemented to calculate a leveraged attribute compliance and weightage, according to an embodiment of the present invention.

FIG. 11 is an additional flow chart diagram depicting additional various aspects for leveraging production deployments to accelerate inflight deployments, in which an embodiment of the present invention may be implemented.

### DETAILED DESCRIPTION OF THE DRAWINGS

Large transformation programs typically include multiple applications that could have several dispositions, (e.g., target dispositions such as modernize, containerize, like-to-like migration, re-platform, and other functionality), which are typically identified as part of wave planning and realized over a period of time.

As part of such transformations, there are a variety of ways of working through an operating model for a particular program that serves to transform people, processes, and technology. Often, a considerable amount of time is expended in constructing a blueprint for these target applications and taking the applications through a conventional blueprint execution model to production.

These initial sets of application are mainly targeted to define, refine, and execute these new target operating models. Organizations often believe that lessons learnt from these initial deployments will expedite the next set of applications that are in the pipeline; but seldom are these benefits realized because of a lack of automation, a lack of standardization, and a lack of codification applied holistically and in an ongoing fashion.

To realize these benefits previously described, but are not currently implemented, the mechanisms of the illustrated embodiments, in contrast to the current state of the art, serve to leverage deployments in production as discrete units that are built through a combination of several approved patterns and reference implementations. These deployments are then leveraged as “gold standards” against which future inflight deployments can be reviewed to help accelerate future deployments, and their path to production, as will be further described, following.

The mechanisms of the illustrated embodiments also provide the ability to expedite pattern updates within implemented production application implementations through, for example, traced metadata, and assist in acceleration of continuous compliance, not at the component level, but at the application level. These and other novel aspects of the illustrated embodiments will be further described in additional detail, following.

It should be noted that one or more calculations may be performed using various mathematical operations or functions that may involve one or more mathematical operations (e.g., solving differential equations or partial differential equations analytically or computationally, using addition, subtraction, division, multiplication, standard deviations, means, averages, percentages, statistical modeling using statistical distributions, by finding minimums, maximums or similar thresholds for combined variables, etc.).

In general, as may be used herein, “optimize” may refer to and/or defined as “maximize,” “minimize,” “best,” or attain one or more specific targets, objectives, goals, or intentions. Optimize may also refer to maximizing a benefit to a user (e.g., maximize a trained machine learning scheduling agent benefit). Optimize may also refer to making the most effective or functional use of a situation, opportunity, or resource.

Additionally, optimizing need not refer to a best solution or result but may refer to a solution or result that “is good enough” for a particular application, for example. In some implementations, an objective is to suggest a “best” combination of operations, schedules, PE's, and/or machine learning models/machine learning pipelines, but there may be a variety of factors that may result in alternate suggestion of a combination of operations, schedules, PE's, and/or machine learning models/machine learning pipelines yielding better results. Herein, the term “optimize” may refer to such results based on minima (or maxima, depending on what parameters are considered in the optimization problem). In an additional aspect, the terms “optimize” and/or “optimizing” may refer to an operation performed in order to achieve an improved result such as reduced execution costs or increased resource utilization, whether or not the optimum result is actually achieved. Similarly, the term “optimize” may refer to a component for performing such an improvement operation, and the term “optimized” may be used to describe the result of such an improvement operation.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as code for acceleration of inflight deployments by inflight deployment module 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

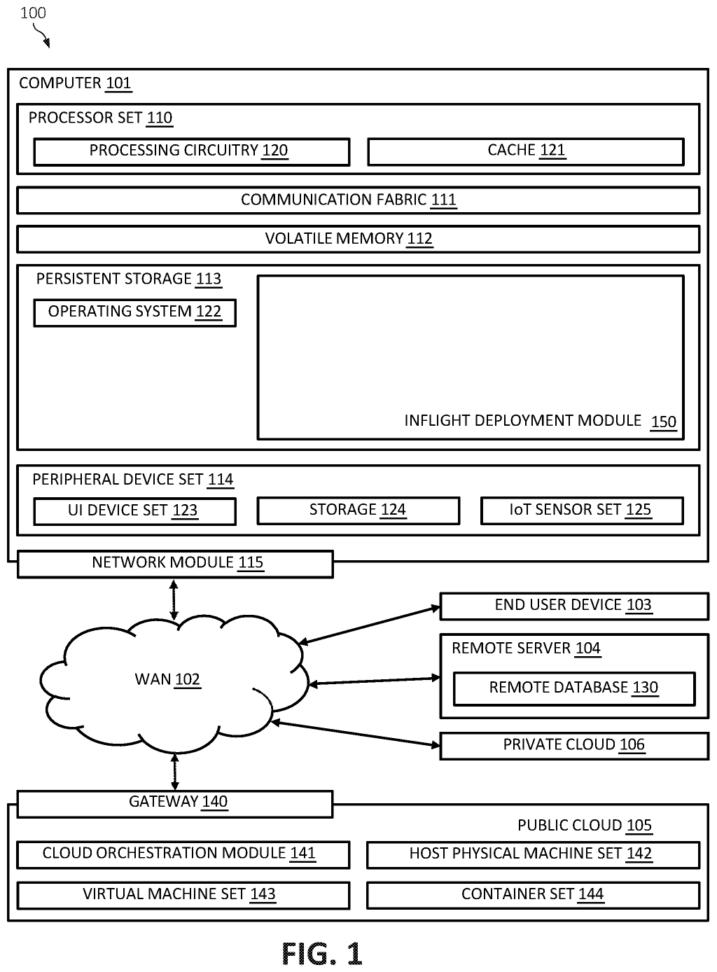

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

As previously mentioned, large transformation programs may include multiple applications that may have several dispositions (target dispositions such as “modernize,” “containerize,” “like-to-like migration,” and “re-platform”), which are typically identified as part of wave planning and realized over a period of time. As part of such transformations, various methodologies of working through a particular operating model that transforms people, processes, and technology may be implemented. Often, a great deal of time is expended building a blueprint for these target applications and taking the applications through a blueprint execution model to production.

These initial set of applications are, among other things, target to define, refine, and execute the new target operating models. Organizations often believe that lessons learnt from these initial deployments will expedite the next set of applications that are in the development pipeline, but seldom are these benefits realized due to such factors as lack of automation, standardization and codification applied holistically and in an ongoing fashion.

In an initial set of applications that go into production, a selection process of discrete services and components is utilized to stitch together these services and components to build patterns, reference architecture and reference implementations that solve common organization problems applicable to multiple applications. These reference implementations, and applications built on the reference implementations, generally go through several reviews for security, governance, risk compliance, architecture, change management, operations management, Day 2 operations, automation, code vulnerability assessments, etc., which could be a combination of manual and automated review processes.

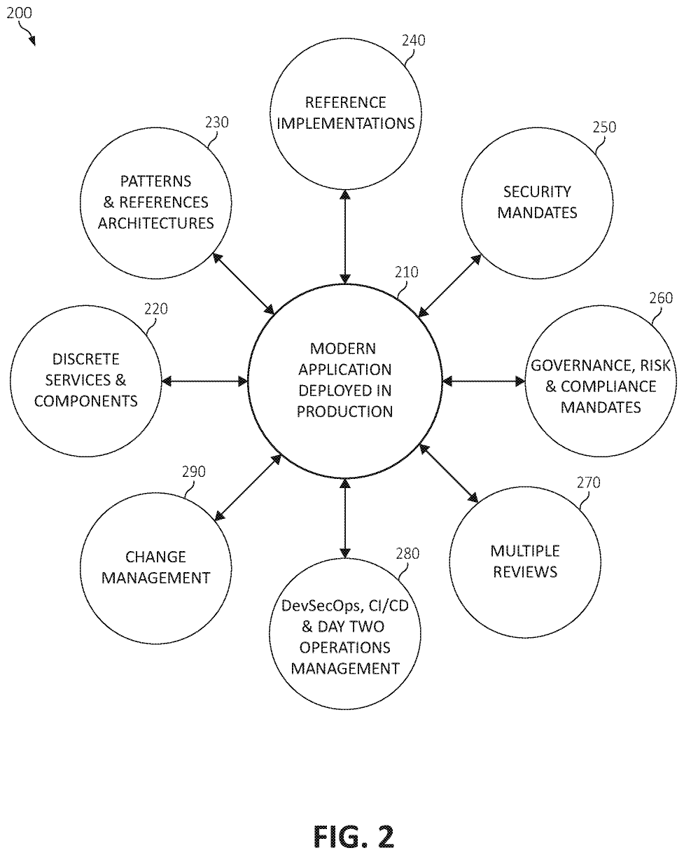

Turning now to FIG. 2, a block/flow chart diagram for a typical selection process 200 in a transformational, modern application or set of applications in development, and as previously described, is shown. Selection process 200 depicts various discrete services and components 220 which are provided in various stages of development a modern application deployed in production (210) using the selection process 200. The various discrete services and/or components 220 may be accompanied in the selection process by various other considerations, such as those of patterns and reference architectures 230, comparison with reference implementations 240, consideration of security mandates 250, consideration of applicable governance, risk and compliance mandates 260, accompanied by multiple reviews 270 in the selection and deployment process, consideration of DevSecOps, CI/CD and Day 2 operations management 280, and finally, consideration of any change management factors 290.

As shown, the discrete services and components 220 provide a backbone of applicable information and are accompanied as shown by the various other components, factors, considerations, review notes, and other matters shown.

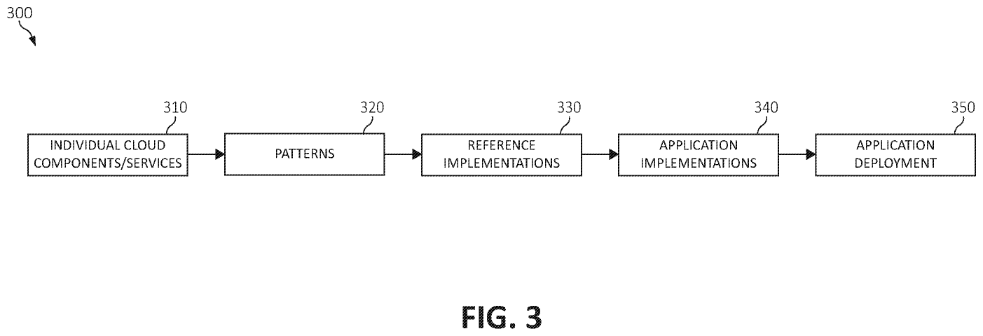

FIG. 3, following, is a flow chart diagram illustrating a typical lifecycle of such a transformational application as the application is built through the process such as selection process 200 depicted in FIG. 2, previously and with inputs/reviews from multiple teams as will be further described. Turning now to FIG. 3, exemplary lifecycle 300 begins by the consideration of individual cloud components/services 310. Recognizable patterns 320, reference implementations 330, various (e.g., previous) application implementations 340 are examined in the process of deployment 350 of a particular application.

As FIG. 3 illustrates in basic form, conventionally a number of manual “toll gates” or “review gates,” and dependencies exist in which an application in process of deployment may pass through by an organization. Complexity is generally directly proportional to the size of the particular organization. As new applications arrive, the deployment 350 of subsequent applications may be enhanced by reusing components 310, patterns 320, previous reference implementations 330, and previous application implementations 340. Additional enhancement may be provided by automation tooling and some degree of process simplification, however, the core attribute of the time spent in reviewing these applications in development through these multiple review gates remains the same. Typically, each generally manual review accomplishes or performs the same set of review activities and very little, if any, acceleration of a new, inflight application occurs.

The conventional system of selection, consideration of previous factors, stitching together of a number of other factors for consideration, and then a manual review in an inflight development of an additional application for deployment presents at least three identifiable challenges. A first challenge is presented of how reviews from a number of stakeholders having lessons learnt and best practices from prior implementation may be leveraged and then accelerated. Implementations using such leverage could be applicable for hybrid or multi cloud scenarios, which can add varying degrees of overall complexity.

A second challenge is presented as to how rectifications or upgrades to existing certified production deployments may be accelerated, when using components, patterns, policies, or designs that are changed at the enterprise level. And third, a final challenge is presented as to how to ensure continuous optimization to gold standard application versions, as new enterprise requirements, standards, or component capabilities emerge.

In one aspect of the following illustrated embodiments, and as previously described, the various challenges described above are addressed, at least partially by leveraging deployments in production as discrete units that are built through a combination of several approved patterns, reference implementations and then, by leveraging these deployments as gold standards against which future inflight deployments can be reviewed, assist in accelerating future deployments and their path to production. Another aspect of the following illustrated embodiments further provides the ability to expedite patterns updates within implemented production application implementations through traced metadata and assists in accelerating continuous compliance, not at the component level, but at the application level.

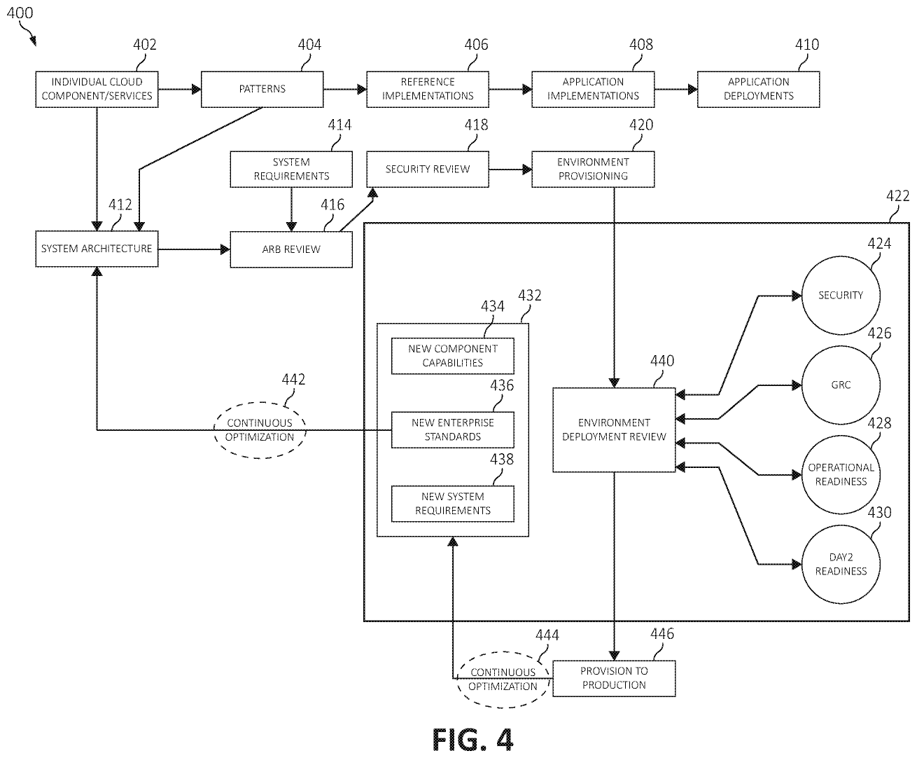

Turning now to FIG. 4, following, a flow chart diagram of an exemplary method 400 for acceleration of in-flight deployment of an exemplary, transformational application, according to the mechanisms of the illustrated embodiments, is depicted. The various exemplary functionality described below in FIG. 4 depicts exemplary impacts of the mechanisms of the present invention to assist in acceleration needs of several stakeholders who need to approve application deployments before they are certified for production rollouts, for example. Further, the illustrated aspects of FIG. 4, among other benefits, serves to continuously improve the application certification process as new system/pattern requirements emerge, new component capabilities are developed by a particular Cloud Service Provider (CSP), and/or new enterprise standards emerge that impact existing Gold standard deployments.

Method 400 considers individual, discrete cloud components and/or services in step 402, which are then combined with identified patterns 404, previous reference implementations 406, application implementations 408, to achieve application deployments 410 as shown. To accomplish this enhancement and accelerated lifecycle, the method 400 considers system architecture 412 (which is provided information from system patterns 404), system requirements 414, an ARB review 416 which is provided to a security review 418, and environment provisioning factors 420.

The combination of each of these components, services, considerations, requirements, reviews, provisioning and other factors as previously described is then provided to acceleration module 422 in accordance with one embodiment of the present invention. Acceleration module 422 considers the factors previously described most recently as environment provisioning 420 in an environment deployment review 440. In accordance with the environment deployment review 440 is shared information in a bilateral manner, such as security data 424, GRC information 426, operational readiness information 428, and Day 2 readiness information 430.

The bilateral information after consideration is then provided to be provisioned for production 446, and subject to continuous optimization following the provisioned for production step 446 and then provided to new factors module 432. New factors module 422 performs such functionality as the consideration of new component capabilities 434, new enterprise standards 436, and new system requirements 438, which receives information provided from the continuous optimization step previously described in step 444 previously. Once all the aggregated information is processed, considered, or otherwise made available, the aggregated information is passed through continuous optimization module 425 into another continuous optimization process 442, after which it is passed back to system architecture step 412 for further consideration, and the process of method 400 continues further.

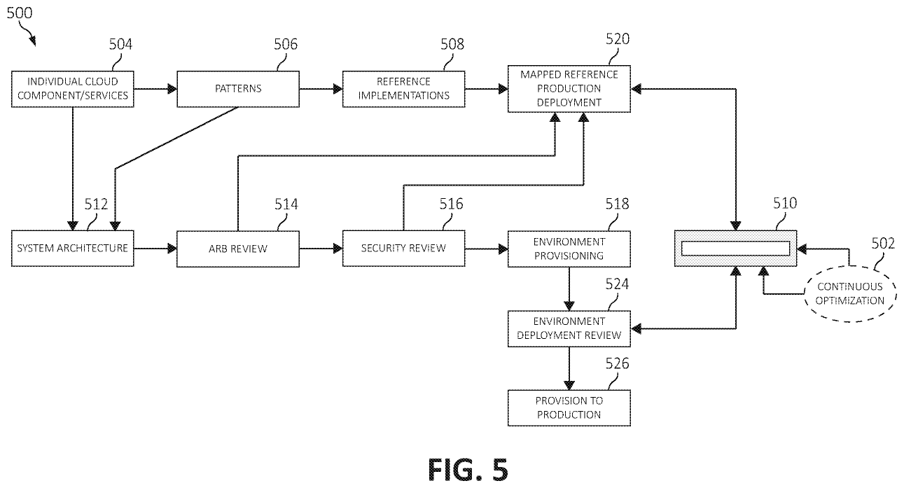

Turning now to FIG. 5, method 500, in flow chart form, illustrates various exemplary aspects of the mechanisms of the present invention that, among other benefits, serve to accelerate inflight deployment of a current application in development towards deployment and production. Method 500, as in previous exemplary embodiments, considers individual cloud component/services 504, identifies and considers patterns 506, and reference implementations 508 that are, in accordance with other information as to be described, to mapped reference production deployment step 520.

Here, as in FIG. 4, the considerations from individual cloud component/services 504 is, among other functionality, provided to system architecture 512. ARB review results and related considerations is provided back to deployment step 520, as the results and considerations are also used in a security review step 516, which is then provided to environment provisioning step 518.

Following provisioning step 518, the refined considerations and other factors are provided to an environment deployment review step 524, and then concluding with a provision to production step 526 as the application proceeds to be provisioned for eventual deployment.

Leveraging step 510 provides, in one embodiment, much of the exemplary functionality according to the mechanisms of the present invention as previously discussed. Leveraging step 510 is performed in conjunction with a continuous, real-time optimization step 502 as shown. The information used by leveraging step 510 is bilaterally shared between deployment step 520 and environment deployment review 524.

The mechanisms as illustrated in FIG. 5 take the illustrated functionality illustrated in FIG. 4, further, to illustrate various aspects of the present invention. In one exemplary embodiment the mechanisms of the illustrated embodiments extract metadata, configuration, established guardrails, and established patterns from deployed implementations; then normalize this metadata and other extracted information to persist within a repository of golden certified implementation metadata, among other extracted information.

The mechanisms then, in one embodiment, perform the same functionality for inflight implementations, and compare, for example, the extracted metadata to determine or identify drifts of inflight implementations with the aforementioned golden implementations. The mechanisms of the illustrated embodiments, in a further aspect, possess the ability to report drifts and manage these drifts throughout the lifecycle of inflight implementations as new versions of inflight implementations come about. The mechanisms of the illustrated embodiments, in one aspect, also update the golden implementation metadata as new golden implementations are certified.

In a further aspect of the illustrated embodiment, continuous optimization functionality (as previously described) is performed by leveraging gold standards as new enterprise requirements, and as new standard or component capabilities emerge. This functionality may, in one embodiment, be accomplished by providing traceability as new patterns emerge, or updates to existing patterns are identified which require existing production implementations to be upgrades and new versions of the golden certified metadata are published and/or updated.

From the approach depicted as an exemplary embodiment of the aspects of the present invention, a variety of usable scenarios may flow therefrom. These usable scenarios may include, but are not limited to accessing drift from gold standards, extracting specific pattern implementation/best practices, or creating a new build, etc.

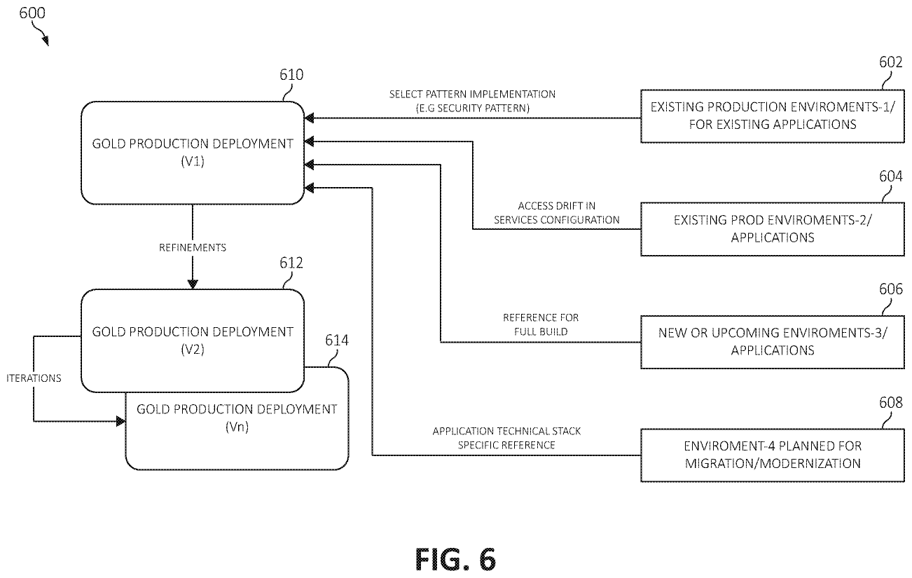

Accordingly, exemplary functionality to this regard is illustrated further in FIG. 6, following, in flow chart form by method 600. Method 600 performs, among other exemplary aspects, certain functionality that leverages various input information to accelerate in flight development of an instant application in development for eventual deployment and distribution as will be further described. Method 600 depicts several gold production deployment versions of the application as shown in Version 1 (V1) 610, Version 2 (V2) 612, and Version 3 (V3) 614.

Each version 612, 612, and 614 is subject to various refinements and iterations as a particular gold standard moves closer to its own deployment, as shown. Along the way, such functionality to leverage existing applications and accelerate inflight development of a current application towards deployment is implemented. For example, in step 602, various existing production environments are considered. In one aspect, various metadata and other information is extracted from the existing production environments. One or more pattern implementations (e.g., security pattern(s)) are selected for a pattern implementation step, and the completed data set of information is returned to gold production deployment 610 as shown.

In a separate exemplary step 604, one or more existing production environments is considered by accessing and identifying drift, for example, in a particular services configuration. The assessed drift is then provided to gold production deployment 610 and then later gold production deployments 612 and 614, incorporation subsequent refinements and iterations as shown.

In an additional exemplary step 606, new or upcoming environments/applications are examined. Implicit in the examination is a determination as to whether some of all of the examined application can serve as a reference for a new build, as the refined and examined information gleaned from the examined application is provided to gold production deployment step 610 as previously described.

Finally, a further environment planned for migration/modernization may be examined in step 608 to determine if am application technical stack specific reference (or the metadata or other information therefrom) may be extracted for use in the gold production deployment 610.

The various exemplary functionality described in FIG. 6, among other aspects described in FIGS. 5, and 4, previously, serves to address many of the previous aforementioned challenges in manually selecting, and stitching together various solutions that may or may not assist an application currently in deployment. For example, the various exemplary functionality compares inflight implementations with certified implementations to identify drifts. In a further example, the various exemplary functionality derives a dynamic decision matrix for each cloud service/component from the certified gold production deployment to be leveraged for scoring against inflight deployment.

In a further example, the various exemplary functionality continuously builds a normalized metadata repository of Golden certified implementation traced back to components and services along with patterns and identifies drifts for applications deployed within the same CSP (Cloud Service Provider) or across different cloud Service providers in a multi-cloud scenario.

In a further example, the various exemplary functionality manages inflight implementations lifecycles through continuous compliance as new versions of inflight implementations are released and identifies and traces noncompliance with golden certified implementations when new enterprise patterns emerge to ensure continuous optimization (for example, when moving from one cloud service provider (CSP) to another). Finally, the various exemplary functionality accelerates migration of applications from one cloud provider to another by leveraging Golden certified implementations from a particular source cloud service provider as a baseline and compares them with inflight implementations for a particular target cloud service provider.

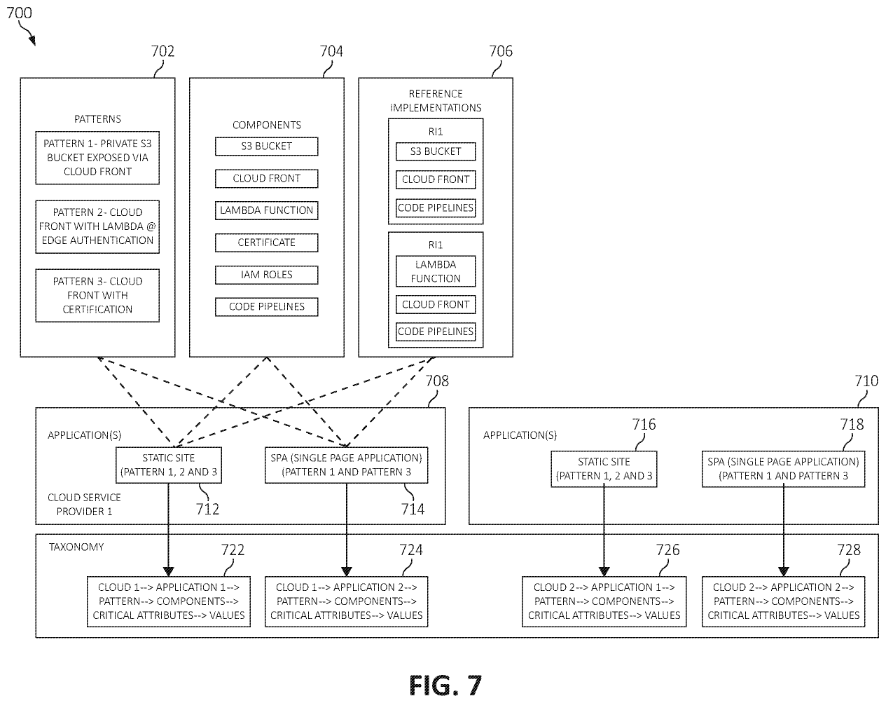

FIG. 7, following, is a block/flow diagram that further illustrates, in one exemplary embodiment, how the various aspects of the present invention, may be implemented in method 700. As a preliminary matter, blocks 702, 704, and 706 represent several cloud components with codified Infrastructure as Code (IaC) templates along with guided patterns on how to bring these components together to solve a use case. The patterns are then codified as reference implementations across multiple clouds that demonstrate end-to-end working of these use cases.

Patterns block 702, components block 704, and reference implementations block 706 are shown with various attendant aspects, characteristics, identifying information, attendant metadata, and other properties. Each of these attendant aspects are customized, codified, categorized, selected, prioritized, and performed various other as-described functionality in the development of applications 708 and 710, where application 708 is hosted on a particular static site 712, and determined to incorporate each of patterns 1, 2, and 3 as shown. Application 708 is also hosted as a single page application 714 and determined to incorporate patterns 1 and 3 as shown. Also as shown, both sets of application 708 are facilitated through a particular cloud service provider.

As a result of the mechanisms of the present invention, as the inflight development continues, each of the types of application 708 exhibits its own particular taxonomy that is relevant to the way, for example, that each version of the application is hosted, or other factors. The application 708 hosted on the static site 712 exhibits the taxonomy 722, having various specific patterns, components, critical attributes, and in turn, values. Similarly, the application 708 executed as a SPA exhibits the taxonomy 724 with attendant patterns, components, critical attributes and values as shown. Similarly as described by application 708, the lifecycle of application 710 flows through static site 716 to a separate cloud having taxonomy 726, where the SPA version of application 710 (718) exhibits the taxonomy 728 as shown.

Accordingly, and as FIG. 7 depicts, a combination of components, patterns and reference implementations result in applications being built targeted for a particular Cloud Service Provider. FIG. 7 then depicts two such applications for each of the target cloud provider. The first such application is static website on a particular host that realizes patterns 1, 2 & 3. The second such application is a single page application that realizes patterns 1 and 3.

Once these applications are deployed in production and become gold standards, the mechanisms of the present invention leverages a combination of CSP (Cloud Service provider) APIs and CLI capabilities to extract relevant information from these application components and build a standard taxonomy. Such a taxonomy could include information such as: Cloud Provider Name/Id, Application Name/Id, Pattern Name/Id, Component Name/Id, Component attribute Name (example S3 http access policy), Component attribute value (example Yes/No/Actual text), Component attribute context (Security, GRC, ARB etc), and other details.

In one exemplary embodiment, this taxonomy will be built for each critical attribute for a given component being part of each pattern. As new patterns emerge and with each production deployment, the mechanisms of the present invention will continue to build this taxonomy repository. The attributes can be added or removed as per enterprise policy guidelines and standards depending on what different stakeholders such as Security, GRC, ARB etc are interested in validating.

This taxonomy repository will later become the critical repository against which taxonomy outcomes from inflight implementations will be compared and reported for compliance. These comparisons can be for applications that are deployed within a single cloud provider or applications that are deployed across multiple cloud providers. In certain scenarios, Cloud component and their capabilities could be different between cloud service providers and in such cases a mapping can be leveraged that could bridge components between different cloud providers.

In another embodiment, the mechanisms of the illustrated embodiments could also be leveraged in helping accelerate migration of applications from one cloud Service Provider (Source) to another Cloud service provider (Target). In this scenario, the present embodiment leverages Golden certified implementations from source cloud service provider as baseline and compares them with inflight implementations for a target cloud service provider.

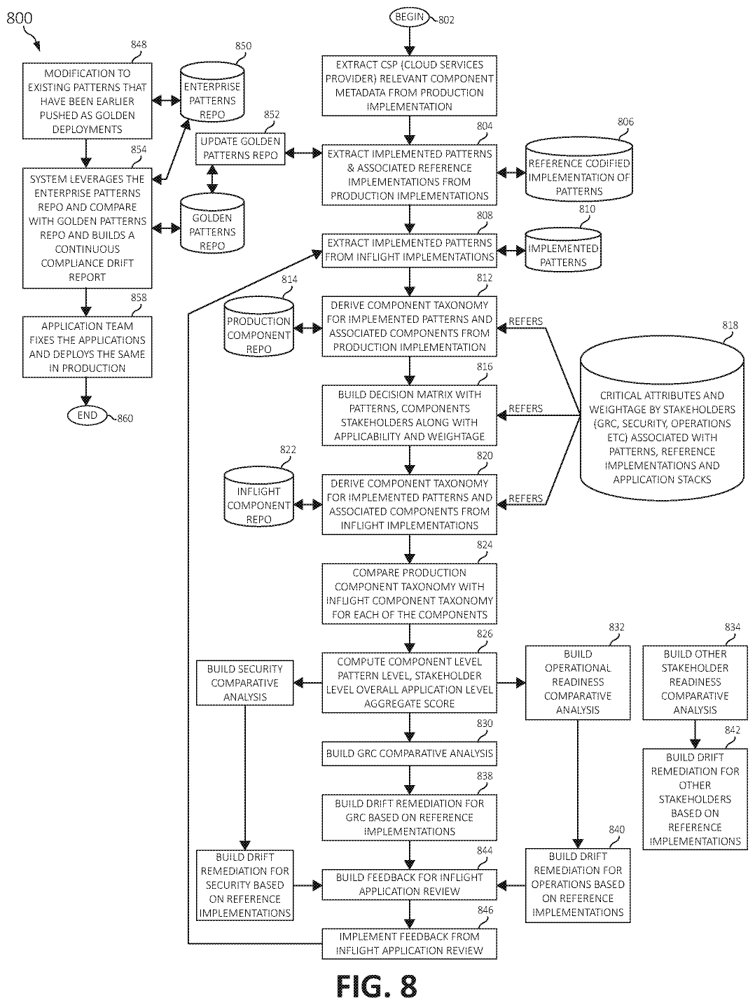

Turning now to FIG. 8, an exemplary method 800 for accelerating inflight development of a transformational application by leveraging production applications is depicted, in accordance with one embodiment of the present invention. Method 800 begins (step 802), given an application that has been deployed in production, with the extraction 804 of cloud provider platform components metadata from the application. These metadata could be infrastructure components, PaaS components and Serverless components, along with relevant services configuration etc. that builds the application. This information can be extracted from IaC (Infrastructure as Code), helm charts, scripts that deploy the application or through other ways depending on how the application has been deployed. For example, in a deployment inclusive of IaC components, there are parsers currently available that can parse IaC templates for common cloud service provider technologies such as Terraform (an IaC tool), that can be leveraged. In one embodiment, the mechanisms of the present invention proceed to extract this information automatically through components that deployed the application, but in other embodiments, the development system deploying the application could be ingested with this information manually.

In step 806, following, method 800 extracts implemented patterns within the application. As demonstrated previously, the application may be comprised of one or more patterns. Components that build the application could be part of more than one pattern. Considering this in view of FIG. 8, previously, the CloudFront component is part of pattern 1 where CloudFront acts as the content delivery network caching capability for content stored in S3 origin. The same CloudFront component also leverages another pattern 2 for supporting authentication through the Lambda@Edge function. The mechanisms of the present invention identify these patterns, for example, through pattern tag values extracted from the components that participate in the pattern (e.g., step 807). The same component can be part of multiple patterns and hence can have multiple pattern values. Alternatively in other embodiments, this information could be extracted from IaC templates or scripts that deploy these components via the command line interface (CLI).

When extracting such information from the production implementation, method 800 could also update the golden deployment patterns repository as shown in step 852. During this step, the system will also extract reference implementation for these patterns from a repository that hosts a mapping of patterns to reference implementations. This repository will further host necessary meta data about how compliance for a given enterprise requirement has been implemented within the reference implementation. Each reference implementation implements a pattern and could demonstrate multiple examples of compliance adherence.

Given an application that is under inflight development, method 800 extracts implemented patterns 810 within the inflight application in step 808. Method 800 will leverage similar techniques as demonstrated in step 806, previously, to extract this information from inflight implementations that need compliance validation.

As a following step 812, among other sources such as a production component repository 814, a component taxonomy is constructed for production implementation through the patterns and component details extracted in steps 804, 806, and 808 Method 800 leverages a combination of CSP (Cloud Service provider) APIs and/or CLI capabilities to extract relevant metadata information from these application components and build a standard taxonomy. Such Taxonomy can include information such as:
1. Application Name/Id
2. Pattern Name/Id
3. Reference implementation metadata
4. Component Name/Id
5. Component attribute Name (example S3 http access policy)
6. Component attribute value (example Yes/No/Actual text)
7. Component attribute context (Security, GRC, Operational, ARB etc)
8. Other details

This taxonomy will be built for each critical attribute for a given component being part of each pattern. The attributes can be added or removed as per enterprise policy guidelines and standards depending on what different stakeholders such as Security, GRC, ARB, Operations etc are interested in validating. These will be maintained in a separate critical attributes repository 818 that the system will be maintaining. The resulting production component taxonomy may be considered as the baseline and gold standard for comparison.

In a following step 816, the method 800 builds a decision matrix based on the production implementation from details extracted in steps 804, 806, and 808 previously. This matrix, in one embodiment, provides component attribute mappings by pattern and stakeholder along with applicability. Along with the applicability, the critical attributes component also provides stakeholder driven weightage for each attribute that could be driven by enterprise standards. Example security related attributes could be weighted highly compared to GRC attributes or earlier in the development lifecycle, the Operational attributes weightage could be lower than others.

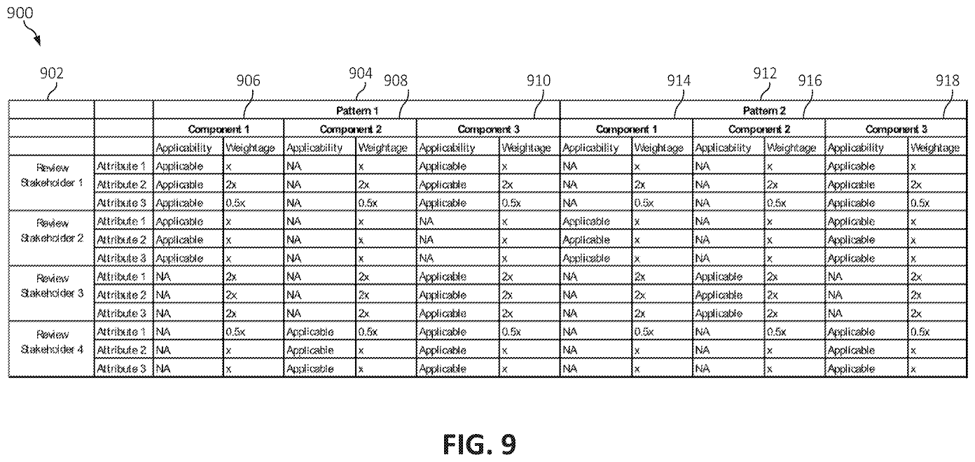

An example of such a decision matrix 900 may, in one embodiment appear as FIG. 9, following, building on patterns, components and stakeholder driven attributes. Matrix 900 is organized by, partly, column 902 which lists a number of review stakeholders, and then by identified patterns 904, 912, and then by components 906, 908, 99, 914, 916, and 918 as shown. Matrix 900, in one exemplary embodiment, is dynamic, and is constructed by method 900 (FIG. 8, previously) to be built by the method 900 for each review cycle.

Returning now back to FIG. 9, method 900 in step 920 proceeds to derive a component taxonomy for inflight implementations by leveraging similar techniques as step 912, previously. In one exemplary embodiment, the method 900 may be building an inflight implementation component taxonomy for the first time or nth time depending on the compliance validation iteration being executed.

In some implementations, method 900 may decide a full set of inflight component taxonomy is required whereas in certain implementation, method 900 may decide that only a partial set of inflight components taxonomy is required. These techniques can help the method 900 by providing faster feedback and/or ensuring the required changes extraction.

For the inflight component taxonomy that has been identified, the method 900 compares the inflight component configuration against a baselined gold standard component configuration by leveraging the taxonomies that were extracted in steps 912 and 920, respectively. The method 900 then identifies patterns that the component belongs to and compares the component configuration for that pattern between the inflight and baselined component configuration. This validation is repeated for all components in the pattern and for all patterns within an application in step 924. In one embodiment, the method 900 may specifically call out any specific components that were found in inflight implementations that could not be found in the gold standard taxonomy.

As a next step, method 900 computes a component level, pattern level, stakeholder level, overall application level, and aggregate score. This will be calculated leveraging the attribute compliance and its weightage, as per several example calculations, following:

Score(Component Level)=Σ(SUM(Attribute Compliance(0 or 1)*Attribute Weightage)/Sum(Number of applicable attributes))

Score(Pattern Level)=Σ(Component Scores for all components participating in a pattern)/Sum(Number of Components participating in a pattern))

Score(Stakeholder Level)=Σ(Component Scores for all components applicable for stakeholder)/Sum(Number of Components participating in a pattern))

Score(Application Level)=Σ(Component Scores for all components)/Sum(Number of Components participating in a pattern))

In certain embodiments, each of these computations can have their own weightages at the component, the pattern, and the stakeholder level as well.

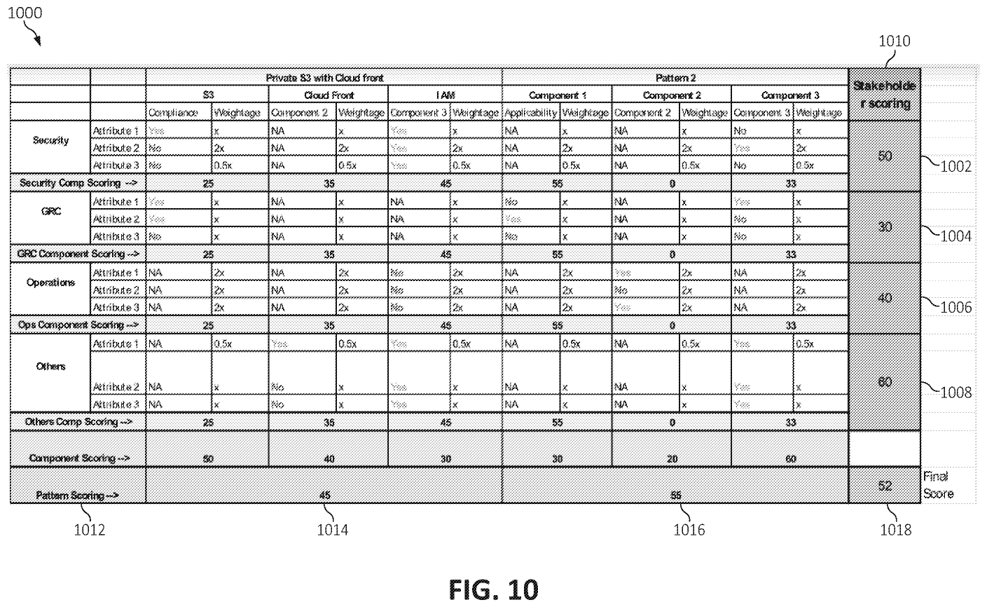

Turning to FIG. 10, following, an exemplary matrix 1000 showing each of the scoring calculations just described. Column 1010 delineates each stakeholder scoring calculation, separated by security (1002), GRC (1004), operations (1006), and others (1008). One of ordinary skill in the art will appreciate, and as previously described, the organization by pattern, component, averages, and totaling as consistent with the calculations described above. The pattern scoring totals 1012 are broken down by each pattern 1014 of 45, pattern 1016 of 55, and final score 1018 of 52.

In steps 1028, following, method 1000 builds an outcome for the inflight implementation with security specific gaps that can be reviewed by a particular security team.

In a parallel step 1030, method 1000 builds an outcome for the inflight implementation with compliance specific gaps that can be reviewed by a GRC team. In step 1032, the method 1000 builds an outcome for inflight implementation with security operational gaps that can be reviewed by an SRE team. Method 1000 may build other stakeholder readiness comparative analysis reports as per individual stakeholder (e.g., step 1034).

In a following series of steps 1036, 1038, 1040, and 1042, the method 1000 leverages the associated reference implementations to the patterns that have identified drifts, and provide remedial recommendations for bridging security, GRC, operational, or other gaps. In step 1044, the method 1000 will produce an overall drift report for the inflight implementation. In one exemplary embodiment, the method 1000 persists and leverage drift details for any subsequent reviews of this inflight implementation (e.g., step 1046).

As one of ordinary skill in the art will appreciate, within an enterprise content, there could be scenarios where the enterprise decides to update an implementation pattern. For example, an enterprise may decide to leverage CloudFlare CDN in place of the existing, implemented CloudFront CDN. This would invalidate the existing golden deployments and enterprises may need a way to continuously monitor and manage this noncompliance and at the same time ensure that any new inflight implementations may not get evaluated against these (now invalid) golden deployments (e.g., step 1048). Accordingly, in step 1054, following, the method 1000 leverages the enterprise patterns repository 1050 and in one exemplary embodiment, always reconcile the golden deployment repo with the enterprise patterns repo (e.g., 1050, 1053). As an outcome of step 1052, the enterprise patterns repository is updated, and that change will trigger a step to compare those with the golden deployment repository 1053. This will invalidate existing golden deployment patterns and hence, those invalidated golden deployment patterns will not be used in subsequent evaluations. At the same time, a drift outcome will be produced that can be leveraged for continuous compliance.

In a following step 1058, once the application team updates the application as per the new pattern and pushes to production, the same process will follow as the control would move to step 1002. For purposes of the present illustration however, the method 1000 then ends (step 1060).

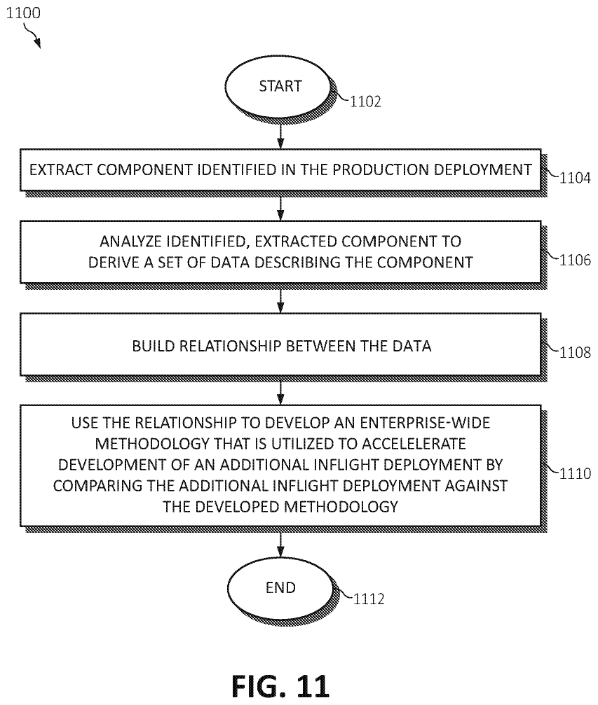

Turning now to FIG. 11, an exemplary method 1100 for accelerating inflight deployments by leveraging production deployments, using a processor in a computing environment, is depicted. Method 1100 begins (1102) with the extraction of one or more components identified in the production deployment (1104). In a following step, the identified, extracted component or components are analyzed to derive a set of data which describes the identified, extracted component (such as a set of metadata, or other data giving information about the component) (1106). In step 1108, following, one or more relationships between the data is built. Finally, in step 1110, this relationship is utilized to develop an enterprise-wide methodology that is further utilized to accelerate development of an additional inflight deployment by comparing the additional inflight deployment against the developed methodology. The method 1100 then ends (step 1112).

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary, a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is:

1. A method for leveraging production deployments to accelerate inflight deployments in a computing environment by one or more processors comprising:
extracting a component which is identified in the production deployment;
analyzing the identified, extracted component to derive a set of data describing the identified, extracted component;
building a relationship between the data; and
using the relationship to develop an enterprise-wide methodology that is utilized to accelerate development of an additional, inflight deployment by comparing the additional, inflight deployment against the developed methodology.

2. The method of claim 1, wherein analyzing the component to derive the set of the data further includes extracting cloud provider platform component metadata.

3. The method of claim 2, wherein the cloud provider platform component metadata further includes infrastructure components, Platform as a Service (PaaS) components, serverless components, and relevant services configuration services configuration components, and
analyzing the component to derive the set of the data further includes extracting information from Infrastructure as Code (IaC), helm charts, or a script deploying an application.

4. The method of claim 1, wherein analyzing the identified, extracted component to derive the set of the data describing the component further includes extracting an identified pattern as the set of the data by analyzing a pattern tag value extracted from a component participating in the identified pattern.

5. The method of claim 4, further including extracting a reference implementation for the pattern from a repository that hosts a mapping of patterns to reference implementations and necessary metadata regarding compliance for a given enterprise requirement implemented within the reference implementation.

6. The method of claim 1, wherein building the relationship between the data further includes building a component taxonomy.

7. The method of claim 6, wherein building the component taxonomy further includes examining at least one of a Cloud Service Provider (CSP) Application Programming Interface (API) or Command Line Interface (CLI) component to extract relevant metadata information.

8. A system for leveraging production deployments to accelerate inflight deployments in a computing environment, comprising:
one or more computers with executable instructions that when executed cause the system to:
extract a component which is identified in the production deployment,
analyze the identified, extracted component to derive a set of data describing the identified, extracted component,
build a relationship between the data, and
use the relationship to develop an enterprise-wide methodology that is utilized to accelerate development of an additional, inflight deployment by comparing the additional, inflight deployment against the developed methodology.

9. The system of claim 8, wherein the executable instructions when executed cause the system to, pursuant to analyzing the component to derive the set of the data, extract cloud provider platform component metadata.

10. The system of claim 9, wherein the cloud provider platform component metadata further includes infrastructure components, Platform as a Service (PaaS) components, serverless components, and relevant services configuration services configuration components, and
wherein the executable instructions when executed cause the system to, pursuant to analyzing the component to derive the set of the data, extract component information from Infrastructure as Code (IaC), helm charts, or a script deploying an application.

11. The system of claim 8, wherein the executable instructions when executed cause the system to, pursuant to analyzing the identified, extracted component to derive the set of the data describing the component, extract an identified pattern as the set of the data by analyzing a pattern tag value extracted from a component participating in the identified pattern.

12. The system of claim 11, wherein the executable instructions when executed cause the system to extract a reference implementation for the pattern from a repository that hosts a mapping of patterns to reference implementations and necessary metadata regarding compliance for a given enterprise requirement implemented within the reference implementation.

13. The system of claim 8, wherein the executable instructions when executed cause the system to, pursuant to building the relationship between the data, build a component taxonomy.

14. The system of claim 13, wherein the executable instructions when executed cause the system to, pursuant to building the component taxonomy, examine at least one of a Cloud Service Provider (CSP) Application Programming Interface (API) or Command Line Interface (CLI) component to extract relevant metadata information.

15. A computer program product for clearing of memory of system in a computing environment, the computer program product comprising:
one or more computer readable storage media, and program instructions collectively stored on the one or more computer readable storage media, the program instruction comprising:
program instructions to extract a component which is identified in the production deployment,
program instructions to analyze the identified, extracted component to derive a set of data describing the identified, extracted component,
program instructions to build a relationship between the data, and
program instructions to use the relationship to develop an enterprise-wide methodology that is utilized to accelerate development of an additional, inflight deployment by comparing the additional, inflight deployment against the developed methodology.

16. The computer program product of claim 15, further including program instructions to, pursuant to analyzing the component to derive the set of the data, extract cloud provider platform component metadata.

17. The computer program product of claim 16, wherein the cloud provider platform component metadata further includes infrastructure components, Platform as a Service (PaaS) components, serverless components, and relevant services configuration services configuration components, and
further including program instructions to, pursuant to analyzing the component to derive the set of the data, extract component information from Infrastructure as Code (IaC), helm charts, or a script deploying an application.

18. The computer program product of claim 15, further including program instructions to, pursuant to analyzing the identified, extracted component to derive the set of the data describing the identified, extracted component, extract an identified pattern as the data by analyzing a pattern tag value extracted from a component participating in the identified pattern.

19. The computer program product of claim 18, further including program instructions to extract a reference implementation for the identified pattern from a repository that hosts a mapping of patterns to reference implementations and necessary metadata regarding compliance for a given enterprise requirement implemented within the reference implementation.

20. The computer program product of claim 15, further including program instructions to, pursuant to building the relationship between the data, build a component taxonomy.
